(19) United States
(12) Patent Application Publication
(10) Pub. No.: US 2018/0049067 A1
(43) Pub. Date: Feb. 15, 2018

(54) TECHNIQUES FOR ENABLING FLEXIBLE GUARD-BANDS FOR A RADIO ACCESS TECHNOLOGY IN NEW RADIO

(71) Applicant: QUALCOMM Incorporated, San Diego, CA (US)

(72) Inventors: Xiaoyin HE, San Diego, CA (US); Krishna Kiran MUKKAVILLI, San Diego, CA (US)

(21) Appl. No.: 15/418,321

(22) Filed: Jan. 27, 2017

Related U.S. Application Data
(60) Provisional application No. 62/374,542, filed on Aug. 12, 2016.

(51) Int. Cl. H04W 28/20; H04L 12/24

(52) U.S. Cl. CPC H04W 28/20; H04L 41/0803; H04W 88/02

(57) ABSTRACT

A method and apparatus for enabling flexible guard-bands for a Radio Access Technology (RAT) during wireless communications are described. The method and apparatus include determining, based on one or more guard-band factors, a guard-band configuration message to configure one or more guard-bands of a RAT established with a user equipment (UE). The method and apparatus include transmitting, to the UE over the RAT, the guard-band configuration message. The method and apparatus include receiving, at a UE from a network entity on a RAT, the guard-band configuration message, and adjusting a bandwidth of each of the one or more guard-bands of the RAT based on the guard-band configuration message, the adjusting further comprises adjusting a bandwidth of a transmission channel of the RAT. The method and apparatus include one or more mechanisms for communicating between the UE and the network entity over the adjusted bandwidth of the transmission channel.

### CLAIM OF PRIORITY UNDER 35 U.SC. § 119

The present Application for Patent claims priority to U.S. Provisional Application No. 62/374,542 entitled “TECHNIQUES FOR ENABLING FLEXIBLE GUARD-BANDS FOR A COMMUNICATION CHANNEL IN NEW RADIO” filed Aug. 12, 2016, which is assigned to the assignee hereof and hereby expressly incorporated by reference herein.

### BACKGROUND

Aspects of this disclosure relate generally to telecommunications, and more particularly to techniques for enabling flexible guard-bands for a Radio Access Technology (RAT) during wireless communications.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems.

These multiple access technologies have been adopted in various telecommunication standards to provide a common protocol that enables different wireless devices to communicate on a municipal, national, regional, and even global level. For example, fifth generation (5G) NR (new radio) communications technology is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information. As the demand for mobile broadband access continues to increase, however, further improvements in NR communications technology and beyond may be desired.

Techniques are needed to provide efficient and improved process when using guard-bands for a communication channel during wireless communications. In certain instances, as the next generation of wireless communications come into existence, specific latency and reliability requirements are needed to be met in order to ensure adequate levels of wireless communications. Specifically, guard-bands used in multi-channel communications may limit cross-channel interference at the edges of frequency band of each respective communication channel. However, these guard-bands are bandwidth dependent and do not allow for flexibility of their respective bandwidth length in different scenarios of various bandwidth deployments. Thus, improvements in enabling more effective use of flexible guard-bands for a RAT during wireless communication are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method includes enabling flexible guard-bands for a Radio Access Technology (RAT) during wireless communications. The described aspects include receiving, at a user equipment (UE) from a network entity on a RAT, a guard-band configuration message to configure one or more guard-bands of the RAT based on one or more guard-band factors. The described aspects further include adjusting a bandwidth of each of the one or more guard-bands of the RAT based on the guard-band configuration message, the adjusting further comprises adjusting a bandwidth of a transmission channel of the RAT based on adjusting the bandwidth of each of the one or more guard-bands of the RAT. The described aspects further include communicating with the network entity over the adjusted bandwidth of the transmission channel in response to adjusting the bandwidth of each of the one or more guard-bands of the RAT.

In another aspect, an apparatus for enabling flexible guard-bands for a RAT during wireless communications may include a transceiver, a memory; and at least one processor coupled to the memory and configured to receive, at a UE from a network entity on a RAT, a guard-band configuration message to configure one or more guard-bands of the RAT based on one or more guard-band factors. The described aspects further adjust a bandwidth of each of the one or more guard-bands of the RAT based on the guard-band configuration message, the adjusting further comprises adjusting a bandwidth of a transmission channel of the RAT based on adjusting the bandwidth of each of the one or more guard-bands of the RAT. The described aspects further communicate with the network entity over the adjusted bandwidth of the transmission channel in response to adjusting the bandwidth of each of the one or more guard-bands of the RAT.

In another aspect, a computer-readable medium may store computer executable code for enabling flexible guard-bands for a RAT during wireless communications. The described aspects include code for receiving, at a UE from a network entity on a RAT, a guard-band configuration message to configure one or more guard-bands of the RAT based on one or more guard-band factors. The described aspects further include code for adjusting a bandwidth of each of the one or more guard-bands of the RAT based on the guard-band configuration message, the code for adjusting further comprises code for adjusting a bandwidth of a transmission channel of the RAT based on adjusting the bandwidth of each of the one or more guard-bands of the RAT. The described aspects further include code for communicating with the network entity over the adjusted bandwidth of the transmission channel in response to adjusting the bandwidth of each of the one or more guard-bands of the RAT.

In another aspect, an apparatus for enabling flexible guard-bands for a RAT during wireless communications is described. The described aspects include means for receiving, at a UE from a network entity on a RAT, a guard-band configuration message to configure one or more guard-bands of the RAT based on one or more guard-band factors. The described aspects further include means for adjusting a bandwidth of each of the one or more guard-bands of the RAT based on the guard-band configuration message, the code for adjusting further comprises code for adjusting a bandwidth of a transmission channel of the RAT based on adjusting the bandwidth of each of the one or more guard-bands of the RAT. The described aspects further include means for communicating with the network entity over the adjusted bandwidth of the transmission channel in response to adjusting the bandwidth of each of the one or more guard-bands of the RAT.

In accordance with another aspect, a method includes enabling flexible guard-bands for a RAT during wireless communications. The described aspects include determining, based on one or more guard-band factors, a guard-band configuration message to configure one or more guard-bands of a RAT established with a UE. The described aspects further include transmitting, to the UE over the RAT, the guard-band configuration message. The described aspects further include communicating with the UE over an adjusted bandwidth of the transmission channel in response to the UE adjusting a bandwidth of each of the one or more guard-bands of the RAT based on the guard-band configuration message.

In another aspect, an apparatus for enabling flexible guard-bands for a RAT during wireless communications may include a transceiver, a memory; and at least one processor coupled to the memory and configured to determine, based on one or more guard-band factors, a guard-band configuration message to configure one or more guard-bands of a RAT established with a UE. The described aspects further transmit, to the UE over the RAT, the guard-band configuration message. The described aspects further communicate with the UE over an adjusted bandwidth of the transmission channel in response to the UE adjusting a bandwidth of each of the one or more guard-bands of the RAT based on the guard-band configuration message.

In another aspect, a computer-readable medium may store computer executable code for enabling flexible guard-bands for a RAT during wireless communications. The described aspects include code for determining, based on one or more guard-band factors, a guard-band configuration message to configure one or more guard-bands of a RAT established with a UE. The described aspects further include code for transmitting, to the UE over the RAT, the guard-band configuration message. The described aspects further include code for communicating with the UE over an adjusted bandwidth of the transmission channel in response to the UE adjusting a bandwidth of each of the one or more guard-bands of the RAT based on the guard-band configuration message.

In another aspect, an apparatus for enabling flexible guard-bands for a RAT during wireless communications is described. The described aspects include means for determining, based on one or more guard-band factors, a guard-band configuration message to configure one or more guard-bands of a RAT established with a UE. The described aspects further include means for transmitting, to the UE over the RAT, the guard-band configuration message. The described aspects further include means for communicating with the UE over an adjusted bandwidth of the transmission channel in response to the UE adjusting a bandwidth of each of the one or more guard-bands of the RAT based on the guard-band configuration message.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIGS. 1 and 2 are schematic diagrams of a communication network including an aspect of an enablement component during wireless communications in accordance with various aspects of the present disclosure.

FIGS. 3 and 4 are flow diagrams illustrating example methods of enabling flexible guard-bands for a RAT during wireless communications in accordance with various aspects of the present disclosure.

FIG. 5 is a diagram of example guard-bands enabled for a RAT during wireless communications in accordance with various aspects of the present disclosure.

FIG. 6 is a diagram of flexible guard-bands enabled for a RAT during wireless communications in accordance with various aspects of the present disclosure.

FIG. 7 is a conceptual data flow diagram illustrating the data flow between different means/components in an exemplary apparatus including a enablement component in accordance with the present aspects.

FIG. 8 is a diagram illustrating an example of a hardware implementation for an apparatus employing a processing system including a enablement component in accordance with the present aspects.

FIG. 9 is a conceptual data flow diagram illustrating the data flow between different means/components in an exemplary apparatus including a enablement configuration component in accordance with the present aspects.

FIG. 10 is a diagram illustrating an example of a hardware implementation for an apparatus employing a processing system including a enablement configuration component in accordance with the present aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to enabling flexible guard-bands for a RAT during wireless communications. In particular, guard-bands are typically used in multi-channel cellular communications and unlicensed wireless communications, such as, but not limited to, Long Term Evolution (LTE) and IEEE 802.11. For example, guard-bands may provide isolation between channels and between bands, and may reduce emission levels and cross interference at a channel's edge and band's edge. In an aspect, systems operating on both sides of a band edge may be different. In this aspect, for example, one side may correspond to a Global System for Mobile Communications (GSM) system while the other side may correspond to an LTE system. In another example, one side may correspond to an LTE Time Division Duplex (TDD) system while the other side may correspond to an LTE Frequency Division Duplex (FDD) system. In this example, the boundaries may occur at band edges of LTE FDD in band 3 (B3) and LTE TDD in B39, LTE TDD in B39 and LTE FDD in B1, and LTE FDD in B7 and LTE TDD in B38 operating in a geographical area. Furthermore, systems operating on both sides of a channel edge may be identical, such as LTE TDD, but systems on both sides may not be synchronized; or synchronized but with different downlink-uplink configurations as in the instances of LTE TDD in B38, B40, B42, and B43.

Moreover, as the next generation of wireless communications come into existence (e.g., 5G NR communications), fragmentation of spectrum allocation is expected due to limited availability of the wideband spectrum. As a result, each spectrum may face different band edge emission regulations. However, traditionally guard-bands are defined either as operating bandwidth dependent or as fixed guard-band. For operating bandwidth dependent, guard-bands may be configured as ten (10) percent of the operating bandwidth. Therefore, a need exists for a communication implementation that fulfills the throughput, latency and reliability requirements for the next generation of wireless communications (e.g., 5G NR communications) by making more effective use of the bandwidth resources available and rely less on fixed or set bandwidth usage.

Accordingly, in some aspects, the present methods and apparatuses may provide an efficient solution, as compared to legacy solutions, by enabling flexible guard-bands for a RAT during wireless communications. In other words, in the present aspects, a network entity may determine flexible guard-bands for a UE that it is in communication with in order to satisfy emission, throughput, latency and reliability requirements. As such, the present aspects provide one or more mechanisms for determining, based on one or more guard-band factors, a guard-band configuration message to configure one or more guard-bands of a RAT established with a UE. Moreover, the present aspects also provide one or more mechanisms for transmitting, to the UE over the RAT, the guard-band configuration message. Additionally, the present aspects also provide one or more mechanisms for receiving, at a UE from a network entity on a RAT, a guard-band configuration message to configure one or more guard-bands of the RAT based on one or more guard-band factors. The present aspects further provide one or more mechanisms for adjusting a bandwidth of each of the one or more guard-bands of the RAT based on the guard-band configuration message, the adjusting further comprises adjusting a bandwidth of a transmission channel of the RAT. The present aspects further provide one or more mechanisms for communicating between the UE and the network entity over the adjusted bandwidth of the transmission channel.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to 5G networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

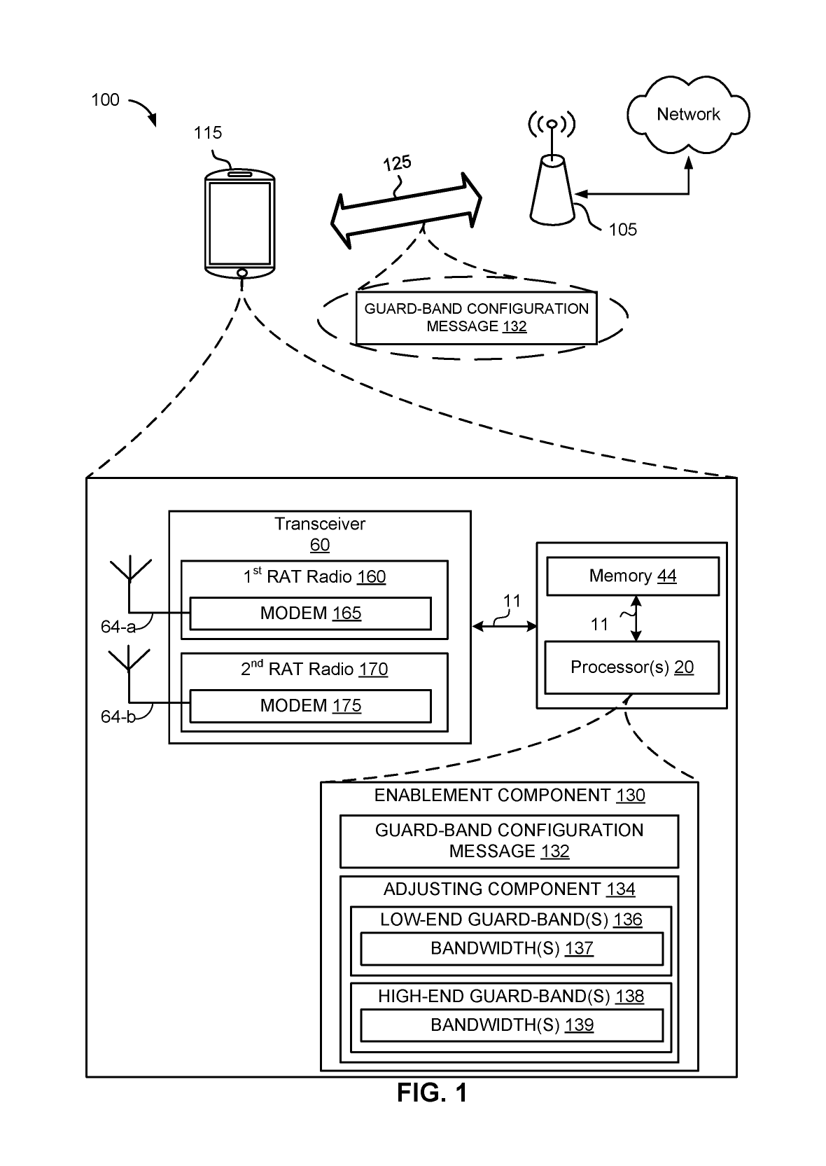

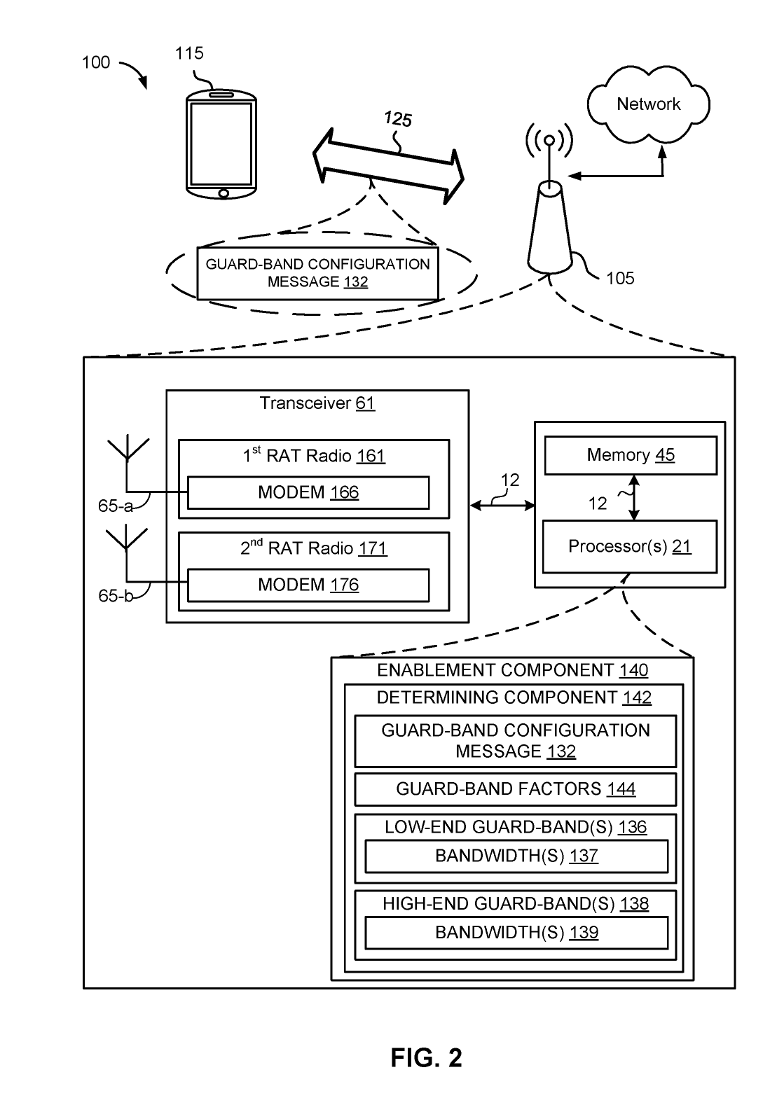

Referring to FIG. 1 and FIG. 2, in an aspect, a wireless communication system 100 includes at least one user equipment (UE) 115 in communication coverage of at least network entities 105. The UE 115 may communicate with network via network entity 105. In an example, UE 115 may transmit and/or receive wireless communication to and/or from network entity 105 via one or more communication channels 125 of a RAT, which may include an uplink communication channel (or simply uplink channel bandwidth region) and a downlink communication channel (or simply downlink channel bandwidth region), such as but not limited to an uplink data channel and/or downlink data channel, a control channel. Such wireless communications may include, but are not limited to, data, audio and/or video information. Moreover, in an example, the wireless communications between UE 115 and network entity 105 may include 5G NR communications.

Referring to FIG. 1, in accordance with the present disclosure, UE 115 may include a memory 44, one or more processors 20 and a transceiver 60. The memory, one or more processors 20 and the transceiver 60 may communicate internally via a bus 11. In some examples, the memory 44 and the one or more processors 20 may be part of the same hardware component (e.g., may be part of a same board, module, or integrated circuit). Alternatively, the memory 44 and the one or more processors 20 may be separate components that may act in conjunction with one another. In some aspects, the bus 11 may be a communication system that transfers data between multiple components and subcomponents of the UE 115. In some examples, the one or more processors 20 may include any one or combination of modem processor, baseband processor, digital signal processor and/or transmit processor. Additionally or alternatively, the one or more processors 20 may include an enablement component 130 for carrying out one or more methods or procedures described herein. In an aspect, the term “component” as used herein may be one of the parts that make up a system, may be hardware, firmware, and/or software, and may be divided into other components. The enablement component 130, and each of its subcomponents, may comprise hardware, firmware, and/or software and may be configured to execute code or perform instructions stored in a memory (e.g., a computer-readable storage medium).

In some examples, the UE 115 may include the memory 44, such as for storing data used herein and/or local versions of applications or communication with enablement component 130 and/or one or more of its subcomponents being executed by the one or more processors 20. Memory 44 can include any type of computer-readable medium usable by a computer or processor 20, such as random access memory (RAM), read only memory (ROM), tapes, magnetic discs, optical discs, volatile memory, non-volatile memory, and any combination thereof. In an aspect, for example, memory 44 may be a computer-readable storage medium (e.g., a non-transitory medium) that stores one or more computer-executable codes defining enablement component 130 and/or one or more of its subcomponents, and/or data associated therewith, when UE 115 is operating processor 20 to execute enablement component 130 and/or one or more of its subcomponents. In some examples, the UE 115 may further include a transceiver 60 for transmitting and/or receiving one or more data and control signals to/from the network via network entity 105. The transceiver 60 may comprise hardware, firmware, and/or software and may be configured to execute code or perform instructions stored in a memory (e.g., a computer-readable storage medium). The transceiver 60 may include a first (1^{st}) radio access technology (RAT) radio 160 (e.g. UMTS/WCDMA, LTE-A, WLAN, Bluetooth, WSAN-FA) comprising a modem 165, and a second (2^{nd}) RAT radio 170 (e.g., 5G) comprising a modem 175. The 1^{st} RAT radio 160 and 2^{nd} RAT radio 170 may utilize one or more antennas 64 for transmitting signals to and receiving signals from the network entity 105. In some examples, the transceiver 60 may only include the 2^{nd} RAT radio 170.

In a blended radio environment such as system 100, different RATs may make use of different channels at different times. Because different RATs are sharing the spectrum and operating partly independently of others, access to one channel may not imply access to another channel. Accordingly, a device capable of transmitting using multiple channels may need to determine whether each channel is available before transmitting. In order to increase bandwidth and throughput, it may be beneficial in some situations to wait for an additional channel to become available rather than transmitting using currently available channel(s).

Similarly, with regard to FIG. 2, network entity 105 may include a memory 45, one or more processors 21 and a transceiver 61. Memory 45, one or more processors 21 and a transceiver 61 may operate in the same and/or similar manner to memory 44, one or more processors 20 and a transceiver 60 of UE 115 described in FIG. 1. Furthermore, memory 45, one or more processors 21 and a transceiver 61 may operate the same and/or similar components including, but not limited to a 1^{st} RAT radio 161 with modem 166, a 2^{nd} RAT radio 171 with modem 176, and antennas 65. Moreover, memory 45, one or more processors 21 and the transceiver 61 may communicate internally via a bus 12. In some examples, the transceiver 61 may only include the 2^{nd} RAT radio 171.

In some examples, the enablement components 130/140 may be configured to enable flexible guard-bands for a communication channel 125 during wireless communications. In an aspect, for example, UE 115 may perform a random access procedure to connect with the network entity 105. Once UE 115 has connected with network entity 105 and has access to the network, UE 115 may communicate with network entity 105 via, at least, an uplink channel bandwidth, downlink channel bandwidth of the communication channel 125 on a first Radio Access Technology (RAT). However, in order to avoid interference with other adjacent RATs, the network entity 105 may enable flexible guard-bands at the edges of the communication channel 125.

Referring to FIG. 2, in an aspect, network entity 105 and/or enablement component 140 may include determining component 142, which may be configured to determine, based on one or more guard-band factors 144, a guard-band configuration message 132 to configure one or more guard-bands (e.g., low-end guard-band(s) 136 and high-end guard-band(s) 138) of a communication channel 125 of a RAT established with a UE 115. The guard-band configuration message 132 may include information corresponding to the width of band and/or location on frequency spectrum. As noted above, the guard-band configuration message 132 may include information for configuring a low-end guard-band(s) 136 and a high-end guard-band(s) 138 of the downlink and uplink of communication channel 125. For example, the low-end guard-band(s) 136 and the high-end guard-band(s) 138 of the communication channel 125 may each provide a frequency region for minimizing interference between the RAT and one or more adjacent RATs. Specifically, the guard-band configuration message 132 includes at least one of the width of the guard-bands, location on the frequency spectrum of the guard-bands and/or the communication channel 125, etc.

In an example, the one or more guard-band factors 144 corresponds to at least one of a deployment band factor, a network category factor, or a UE specific factor. The deployment band factor may include at least one of spectral emission mask (SEM) requirements based on the band, neighbor requirements (e.g., synchronization/asynchronization TDD, TDD/FDD), network entity location (e.g., depending on the location of a network entity, the system may be required to provide additional protection to neighbor deployments). The network category factor may correspond to the cost of a network entity 105 (e.g., a macro eNB) that may either be expected to be able to meet tighter requirements for filtering or the network entity 105 (e.g., HeNB) may use relaxed requirements. The UE specific factor may correspond to the maximum bandwidth allocated to UE 115 which may depend on the deployment as well as UE specific geo-location (e.g., a UE in close proximity to a satellite dish may not be allocated resource blocks (RBs) close to the edge of the band).

In an aspect, network entity 105 and/or enablement component 140 may execute transceiver 61 and/or 2^{nd} RAT radio 171 (e.g., 5G) to transmit, to the UE 115 over the communication channel 125 of the RAT, the guard-band configuration message 132 to configure the UE 115 to adjust a bandwidth 137 of the low-end guard-bands 136 and a bandwidth 139 of the high-end guard-bands 138 of the communication channel 125. For example, transceiver 61 and/or 2^{nd} RAT radio 171 may transmit the guard-band configuration message 132 within a control channel bandwidth region of the communication channel 125 of the RAT. The guard-band configuration message 132 may be transmitted on the Physical Downlink Control Channel (PDCCH) and/or in Radio Resource Control (RRC) messages.

Referring back to FIG. 1, in an aspect, UE 115 may execute enablement component 130 to receive, from a network entity 105 on a communication channel 125 of the RAT, a guard-band configuration message 132 to configure one or more guard-bands of the communication channel 125 (e.g., a low-end guard-band(s) 136 and a high-end guard-band(s) 138) based on one or more guard-band factors 144. For example, transceiver 60 and/or 2^{nd} RAT radio 170 may receive the guard-band configuration message 132 within a control channel bandwidth region of the communication channel 125. As noted above, the low-end guard-band(s) 136 and the high-end guard-band(s) 138 of the communication channel 125 each provide a frequency region for minimizing interference between the communication channel 125 and one or more adjacent communication channels. In an example, the transmission channel may correspond to and/or include an uplink channel bandwidth region and a downlink channel bandwidth region. As such, the guard-band configuration message 132 may include information for configuring the low-end guard-band(s) 136 and the high-end guard-band(s) 138 on an uplink channel bandwidth region and the low-end guard-band(s) 136 and the high-end guard-band(s) 138 on a downlink channel bandwidth region.

In another example, the guard-band configuration message 132 may include information for configuring the low-end guard-band(s) 136 independently of configuring the high-end guard-band(s) 138. For example, the guard-band configuration message 132 may include information only for configuring the low-end guard-band(s) 136, or the guard-band configuration message 132 may include information only for configuring the high-end guard-band(s) 138. Similarly, the guard-band configuration message 132 may include information only for configuring the low-end guard-band(s) 136 and the high-end guard-band(s) 138 associated with the uplink channel bandwidth region, or the low-end guard-band(s) 136 and the high-end guard-band(s) 138 associated with the downlink channel bandwidth region. As such, the guard-band configuration message 132 may be configured by the determining component 142 in a plurality of ways to configure the one or more guard-bands of the communication channel 125.

In an aspect, UE 115 may include adjusting component 134, which may be configured to adjust a bandwidth of each of the one or more guard-bands of the communication channel 125 of the RAT based on the guard-band configuration message 132. Adjusting bandwidth of each of the one or more guard-bands may cause adjustment of a bandwidth of a transmission channel of the communication channel 125. For example, adjusting component 134 may adjust a bandwidth 137 of a low-end guard-band 136 and a bandwidth 139 of a high-end guard-band 138 of the communication channel 125. Furthermore, when a first portion of the transmission channel is associated with an uplink channel bandwidth region and a second portion of the transmission channel is associated with a downlink channel bandwidth region, the guard-band configuration message 132 may include information for configuring the low-end guard-band 136 and the high-end guard-band 138 associated with the uplink channel bandwidth region and the low-end guard-band 136 and the high-end guard-band 138 associated with the downlink channel bandwidth region.

Moreover, as noted above, the guard-band configuration message 132 may include information for configuring the low-end guard-band 136 independently of configuring the high-end guard-band 138. In an example, the bandwidth 137 of the low-end guard-band 136 and the bandwidth 139 of the high-end guard-band 138 for both the uplink channel bandwidth region and the downlink channel bandwidth region may be fixed for the network entity 105 based on a geographic area of UE 115. The geographic area of UE 115 is available to the network entity 105 through positioning techniques employed by the network entity 105. In some examples, the bandwidth 137 of the low-end guard-band 136 may be different from the bandwidth 139 of the high-end guard-band 138. In a further example, the bandwidth 137 of the low-end guard-band 136 and the bandwidth 139 of the high-end guard-band 138 for the uplink channel bandwidth region may be different from the bandwidth 137 of the low-end guard-band 136 and the bandwidth 139 of the high-end guard-band 138 for the downlink channel bandwidth region. Moreover, adjusting component 134 may adjust the bandwidth 137 of the low-end guard-band 136 from a previous bandwidth of the low-end guard-band 136 and the bandwidth 139 of the high-end guard-band 138 from a previous bandwidth of the high-end guard-band 138. In an example, the previous bandwidth of the low-end guard-band 136 corresponds to a minimum bandwidth of the low-end guard-band 136 and the previous bandwidth of the high-end guard-band 138 corresponds to a minimum bandwidth of the high-end guard-band 138.

In an aspect, in response to adjusting the bandwidth of the one or more guard-bands of the communication channel 125, UE 115 and/or enablement component 130 may execute transceiver 60 and network entity 105 and/or enablement component 140 may execute transceiver 61 to communicate over the adjusted bandwidth of the transmission channel. For example, UE 115 may execute transceiver 60 and/or 2^{nd} RAT radio 170 to communicate either on the uplink channel bandwidth region and/or downlink channel bandwidth region with the transceiver 61 and/or 2^{nd} RAT radio 171 of network entity 105. As noted above, the bandwidths of the uplink channel bandwidth region and the downlink channel bandwidth region may be adjusted in response to the adjustment of the bandwidths of the low-end guard-band 136 and the high-end guard-band 138 for both the uplink channel bandwidth region and the downlink channel bandwidth region. The UE 115 may communicate with the network entity 105 while operating in a ultra-reliable low latency communication (URLLC) mode.

A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wearable item such as a watch or glasses, a wireless IoT device, a wireless local loop (WLL) station, or the like. A UE 115 may be able to communicate with macro eNodeBs, small cell eNodeBs, relays, and the like. A UE 115 may also be able to communicate over different access networks, such as cellular or other WWAN access networks, or WLAN access networks.

Additionally, as used herein, the one or more wireless nodes, including, but not limited to, network entity 105 of wireless communication system 100, may include one or more of any type of network component, such as an access point, including a base station or node B, an access node, a radio transceiver, a NodeB, eNodeB (eNB), gNB, Home NodeB, a Home eNodeB, a relay, a peer-to-peer device, an authentication, authorization and accounting (AAA) server, a mobile switching center (MSC), a radio network controller (RNC), etc. In a further aspect, the one or more wireless serving nodes of wireless communication system 100 may include one or more small cell base stations, such as, but not limited to a femtocell, picocell, microcell, or any other base station having a relatively small transmit power or relatively small coverage area as compared to a macro base station.

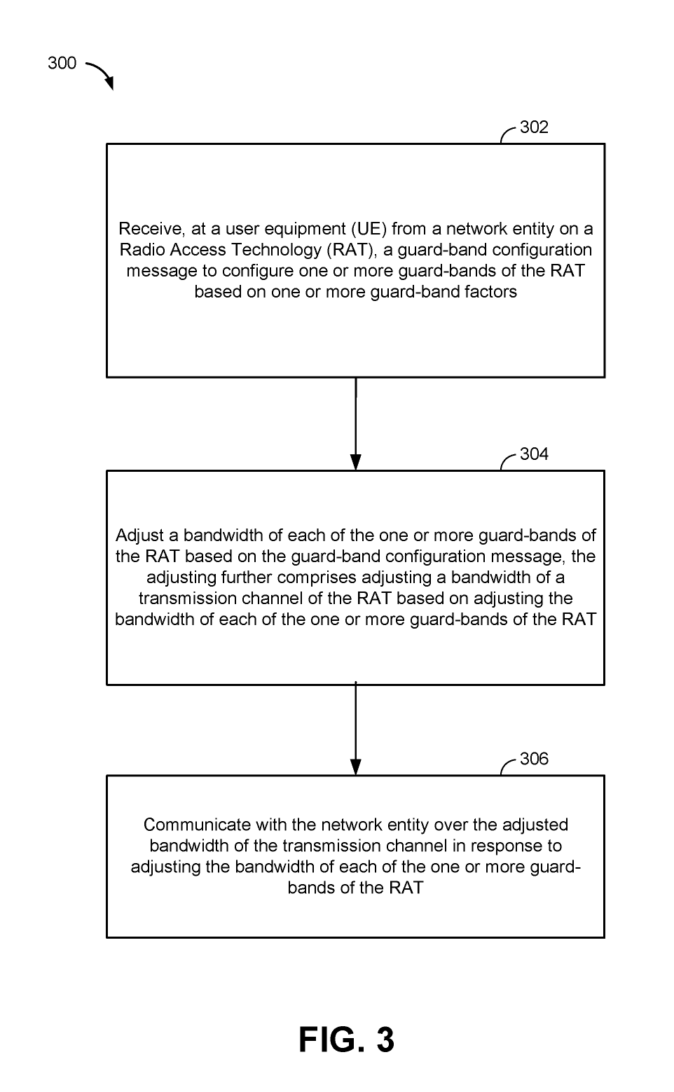

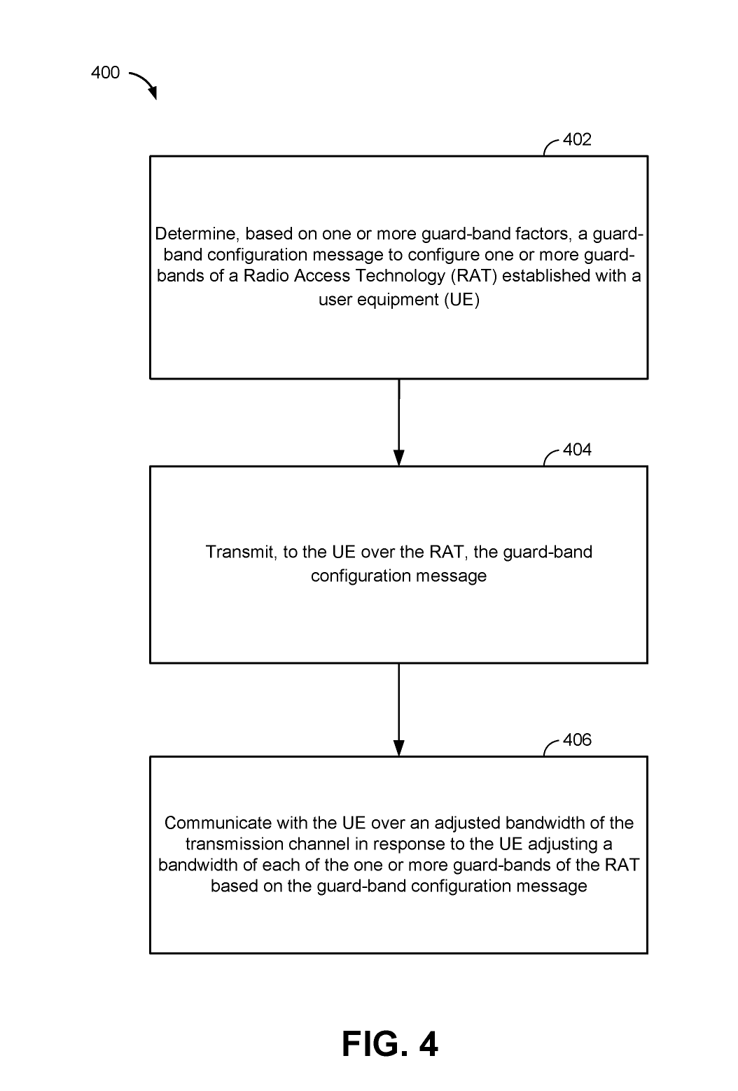

FIG. 3 and FIG. 4 are flow diagrams illustrating examples of methods related to enabling flexible guard-bands for a communication channel with various aspects of the present disclosure. Although the operations described below are presented in a particular order and/or as being performed by an example component, it should be understood that the ordering of the actions and the components performing the actions may be varied, depending on the implementation. Also, although the enablement components 130 and 140 are illustrated as having a number of subcomponents, it should be understood that one or more of the illustrated subcomponents may be separate from, but in communication with, the enablement components 130 and 140, and/or each other. Moreover, it should be understood that any of actions or components described below with respect to the components 130 and 140 and/or their subcomponents may be performed by a specially-programmed processor, a processor executing specially-programmed software or computer-readable media, or by any other combination of a hardware component and/or a software component specially configured for performing the described actions or components.

Referring to FIG. 3, in an aspect, at block 302, method 300 includes receiving, at a UE from a network entity on a RAT, a guard-band configuration message to configure one or more guard-bands of the RAT based on one or more guard-band factors. In an aspect, for example, UE 115 may execute transceiver 60 and/or enablement component 130 (FIG. 1) to receive, from a network entity 105 on a communication channel 125 of the RAT, a guard-band configuration message 132 to configure one or more guard-bands (a low-end guard-band 136 and a high-end guard-band 138) of the communication channel 125 based on one or more guard-band factors 144. In an example, the low-end guard-band 136 and the high-end guard-band 138 of the communication channel 125 may each provide a frequency region for minimizing interference between the RAT and one or more adjacent RATs.

In an aspect, at block 304, method 300 includes adjusting a bandwidth of each of the one or more guard-bands of the RAT based on the guard-band configuration message, the adjusting further comprises adjusting a bandwidth of a transmission channel of the RAT based on adjusting the bandwidth of each of the one or more guard-bands of the RAT. In an aspect, for example, UE 115 may execute enablement component 130 (FIG. 1) and/or adjusting component 134 to adjust a bandwidth of each of the one or more guard-bands of the communication channel 125 of the RAT based on the guard-band configuration message 132, the adjusting further comprises adjusting a bandwidth of a transmission channel of the communication channel 125 based on adjusting the bandwidth of each of the one or more guard-bands of the RAT.

In an aspect, at block 306, method 300 includes communicating with the network entity over the adjusted bandwidth of the transmission channel in response to adjusting the bandwidth of each of the one or more guard-bands of the RAT. In an aspect, for example, UE 115 and/or enablement component 130 (FIG. 1) may execute transceiver 60 (and more specifically 2^{nd} RAT radio 170 (e.g., 5G)) to communicate with the network entity 105 over the adjusted bandwidth of the transmission channel in response to adjusting the bandwidth of each of the one or more guard-bands of the RAT.

Referring to FIG. 4, in an aspect, at block 402, method 400 includes determining, based on one or more guard-band factors, a guard-band configuration message to configure one or more guard-bands of a RAT established with a UE. In an aspect, for example, network entity 105 may execute enablement component 140 (FIG. 2) and/or determining component 142 to determine, based on one or more guard-band factors 144, a guard-band configuration message 132 to configure one or more guard-bands of a communication channel 125 established with a UE 115. As noted above, the low-end guard-band 136 and the high-end guard-band 138 of the communication channel 125 may each provide a frequency region for minimizing interference between the communication channel 125 and one or more adjacent communication channels.

In an aspect, at block 404, method 400 includes transmitting, to the UE over the RAT, the guard-band configuration message. In an aspect, for example, network entity 105 and/or enablement component 140 (FIG. 2) may execute transceiver 61 to transmit, to the UE 115 over the communication channel 125, the guard-band configuration message 132.

In an aspect, at block 406, method 400 includes communicating with the UE over an adjusted bandwidth of the transmission channel in response to the UE adjusting a bandwidth of each of the one or more guard-bands of the RAT based on the guard-band configuration message. In an aspect, for example, network entity 105 and/or enablement component 140 (FIG. 2) may execute transceiver 61 to communicate with the UE 115 over an adjusted bandwidth of the transmission channel in response to the UE 115 adjusting a bandwidth of each of the one or more guard-bands of the communication channel 125 based on the guard-band configuration message 132.

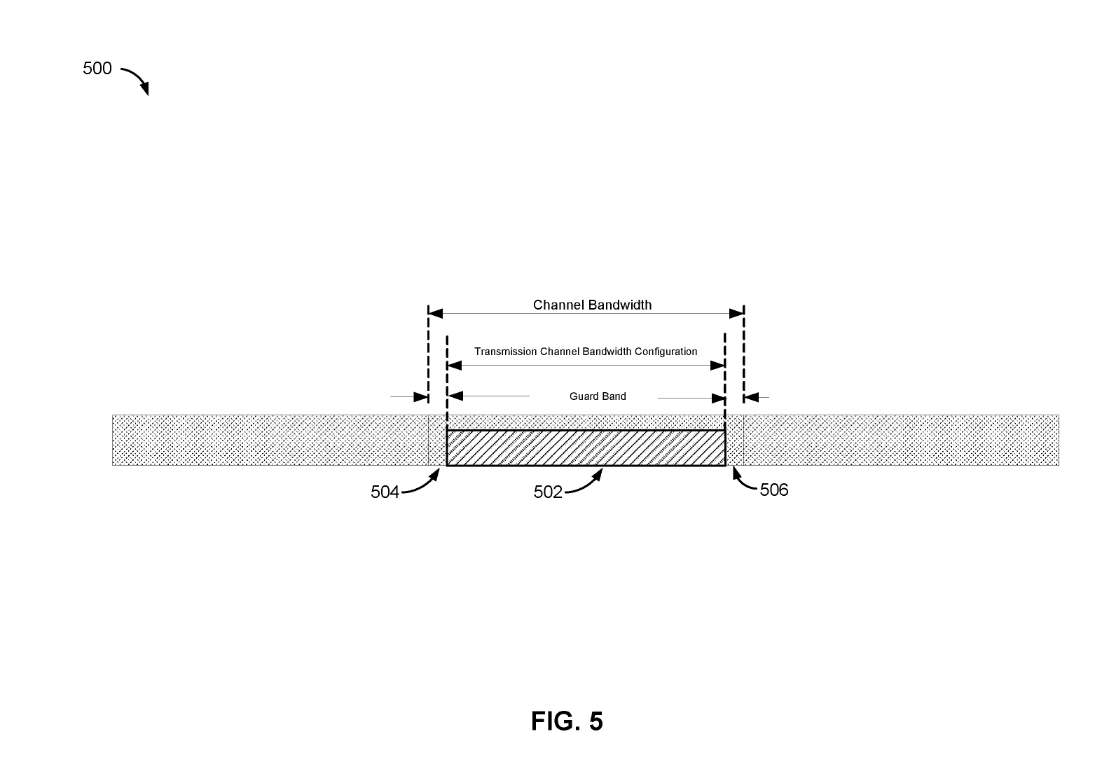

FIG. 5 illustrates an example communication channel 500 of a RAT with static guard-bands enabled during wireless communications. For example, a communication channel 500, similar to communication channel 125 (FIG. 1) of a RAT, may include a channel bandwidth, a transmission channel bandwidth of the transmission channel, and guard-band for the one or more guard-bands. The communication channel may be established between a network entity, similar to network entity 105 (FIG. 1), and a UE, similar to UE 115 (FIG. 1).

In an aspect, the communication channel 500 may include a communication channel bandwidth region 502 that corresponds to a downlink channel bandwidth region, uplink channel bandwidth region in FDD system, or both in TDD system. Furthermore, the guard-bands are not configured to be flexible, as such, low-end guard-band region 504 and high-end guard-band region 506 are static. That is, the bandwidth for both regions 504 and 506 are not adjustable through the course of communications between UE 115 and network entity 105. In some aspects, guard-band regions 504 and 506 are defined either as operating bandwidth dependent or as fixed guard-band. For operating bandwidth dependent, guard-bands may be configured as ten (10) percent of the operating bandwidth (i.e., the channel bandwidth of communication channel 500).

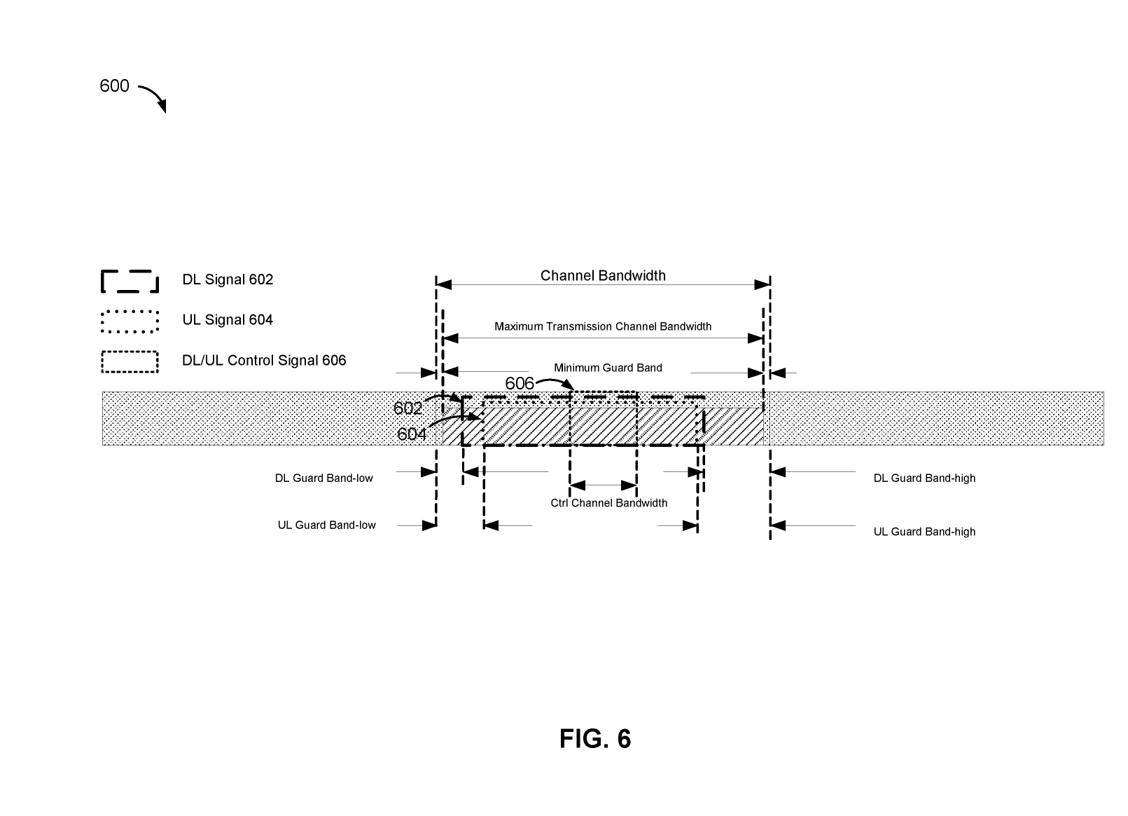

FIG. 6 illustrates an example communication channel 600 of a RAT with flexible guard-bands enabled during wireless communications. For example, a communication channel 600, similar to communication channel 125 (FIG. 1) of a RAT, may include a channel bandwidth (MHz), a maximum transmission channel bandwidth (MHz) of the transmission channel, and minimum guard-band (MHz) for the one or more guard-bands. The communication channel may be established between a network entity, similar to network entity 105 (FIG. 1), and a UE, similar to UE 115 (FIG. 1).

In an aspect, the communication channel 600 may include a downlink channel bandwidth region 602, uplink channel bandwidth region 604, and a control channel region 606. Furthermore, the network entity may enable flexible guard-bands by configuring the bandwidths of the low-end guard-band and the high-end guard-band. The network entity may transmit a guard-band configuration message on bandwidths associated with the control channel 606 to the UE in order to instruct the UE to adjust the bandwidths of the low-end guard-band and the high-end guard-band based on one or more guard-band factors. The control channel 606 may be configured at the center of the communication channel 600 with a specific bandwidth so as to prevent the control channel 606 from overlapping with the guard-bands.

In some aspects, the UE may be instructed to adjust the bandwidths of the low-end guard-band and the high-end guard-band associated with the downlink channel bandwidth region 602 differently from the bandwidths of the low-end guard-band and the high-end guard-band associated with the uplink channel bandwidth region 604. Thus, as depicted in FIG. 6, the bandwidth of the low-end guard-band of the downlink channel bandwidth region 602 may be less than the bandwidth of the low-end guard-band of the uplink channel bandwidth region 604. Similarly, the bandwidth of the high-end guard-band of the downlink channel bandwidth region 602 may be less than the bandwidth of the high-end guard-band of the uplink channel bandwidth region 604. As such, the UE and the network entity may communicate across a larger bandwidth on the downlink channel bandwidth region than on the uplink channel bandwidth region, or vice versa. FIG. 6 is shown for TDD system, but it could apply to FDD system as well, where uplink and downlink frequencies are separated.

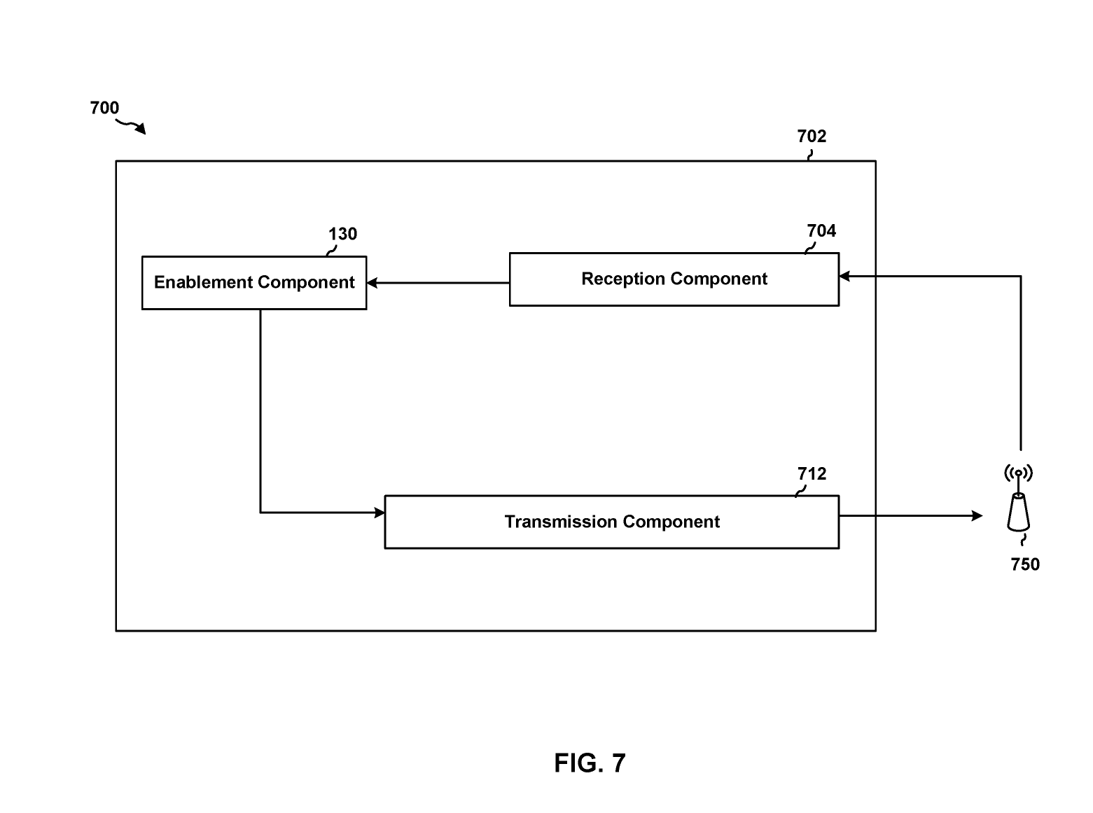

FIG. 7 is a conceptual data flow diagram 700 illustrating the data flow between different means/components in an exemplary apparatus 702 that includes enablement component 130. The apparatus 702 may be a UE, for example, UE 115 of FIG. 1. The apparatus 702 includes reception component 704 that, in an aspect, receives, at a UE from a network entity on a RAT, a guard-band configuration message to configure one or more guard-bands of the RAT based on one or more guard-band factors. The apparatus 702 includes a enablement component 130 that adjusts a bandwidth of each of the one or more guard-bands of the RAT based on the guard-band configuration message, the adjusting further comprises adjusting a bandwidth of a transmission channel of the RAT based on adjusting the bandwidth of each of the one or more guard-bands of the RAT. In an aspect, the apparatus 702 further includes a transmission component 712 that communicates with the network entity over the adjusted bandwidth of the transmission channel in response to adjusting the bandwidth of each of the one or more guard-bands of the RAT.

The apparatus may include additional components that perform each of the blocks of the method 300 in the aforementioned flowchart of FIG. 3. As such, each block in the aforementioned flowchart of FIG. 3 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

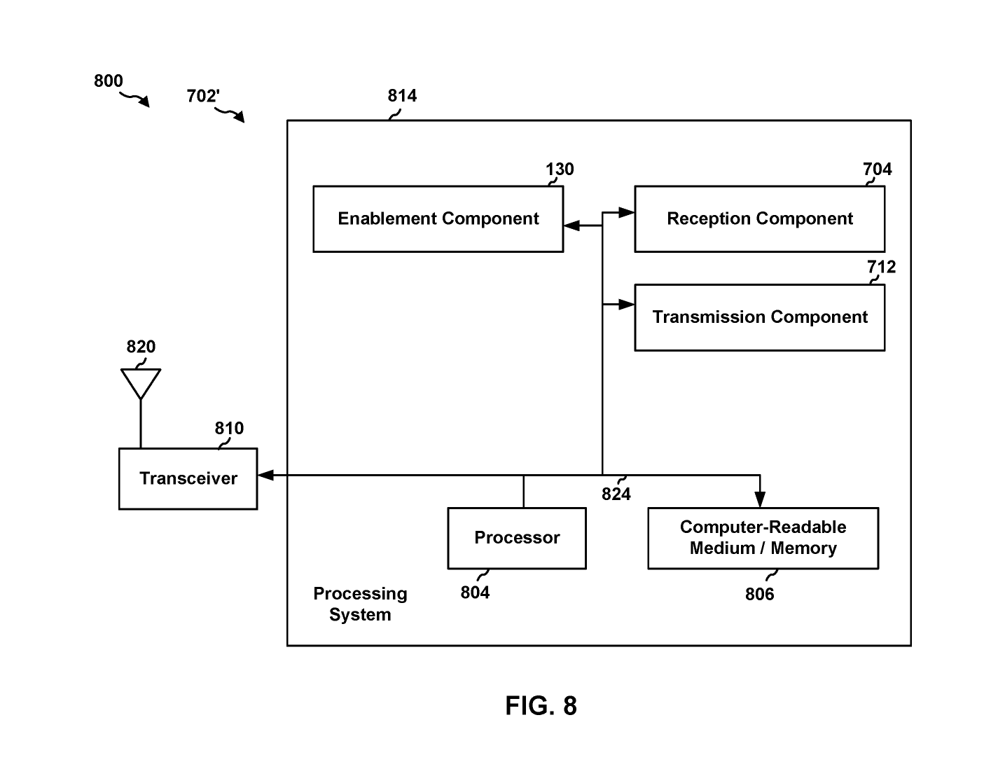

FIG. 8 is a diagram 800 illustrating an example of a hardware implementation for an apparatus 702′ employing a processing system 814 that includes the enablement component 130. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, which may be the same as or similar to processor(s) 20 (FIG. 1), the components 704, 712, and the computer-readable medium/memory 806, which may be the same as or similar to memory 44 (FIG. 1). The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 812, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 130, 704, and 712. The components may be software components running in the processor 804, resident/stored in the computer readable medium/memory 806, one or more hardware components coupled to the processor 804, or some combination thereof.

In one configuration, the apparatus 802/702′ for wireless communication includes means for receiving, at a UE from a network entity on a RAT, a guard-band configuration message to configure one or more guard-bands of the RAT based on one or more guard-band factors. The apparatus further includes means for adjusting a bandwidth of each of the one or more guard-bands of the RAT based on the guard-band configuration message, the adjusting further comprises adjusting a bandwidth of a transmission channel of the RAT. Additionally, the apparatus includes means for communicating with the network entity over the adjusted bandwidth of the transmission channel.

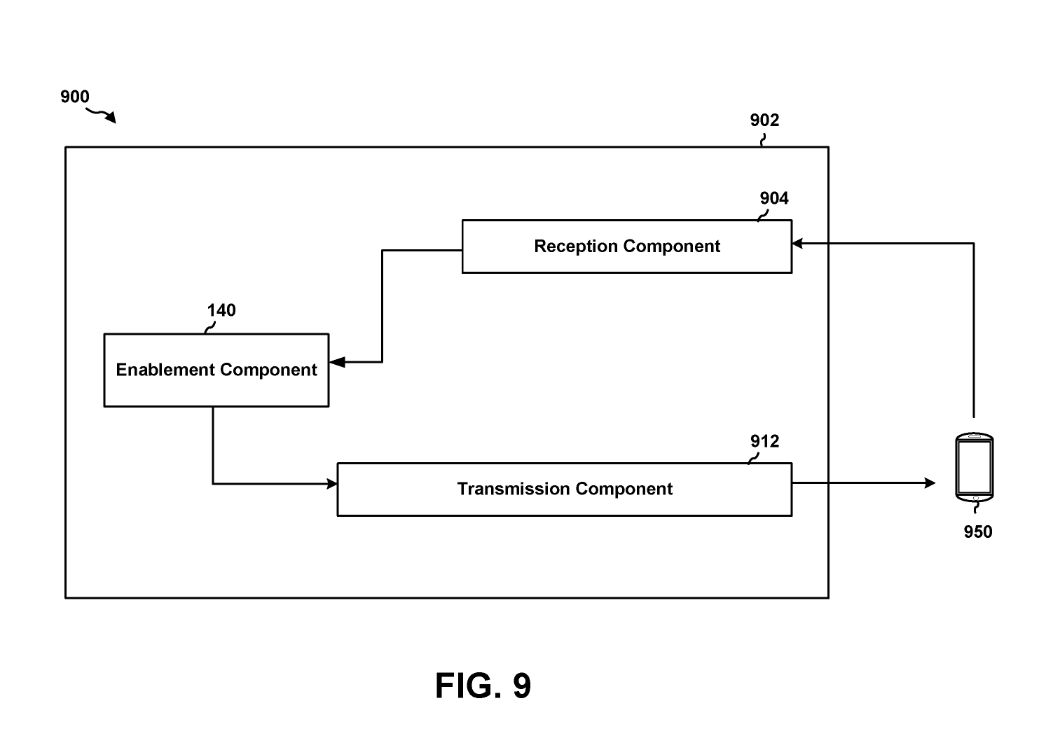

FIG. 9 is a conceptual data flow diagram 900 illustrating the data flow between different means/components in an exemplary apparatus 902 that includes the measurement enablement component 140. The apparatus 902 may be a network entity, for example, network entity 105 of FIG. 2. The apparatus 902 includes the enablement component 140 that determine, based on one or more guard-band factors, a guard-band configuration message to configure one or more guard-bands of a RAT established with a UE. In an aspect, the apparatus 902 further includes a transmission component 912 that transmits, to the UE over the RAT, the guard-band configuration message. The apparatus 900 includes reception component 904, which along with transmission component 912, communicates with the UE over an adjusted bandwidth of the transmission channel in response to the UE adjusting a bandwidth of each of the one or more guard-bands of the RAT based on the guard-band configuration message

The apparatus may include additional components that perform each of the blocks of the method 400 in the aforementioned flowchart of FIG. 4. As such, each block in the aforementioned flowchart of FIG. 4 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

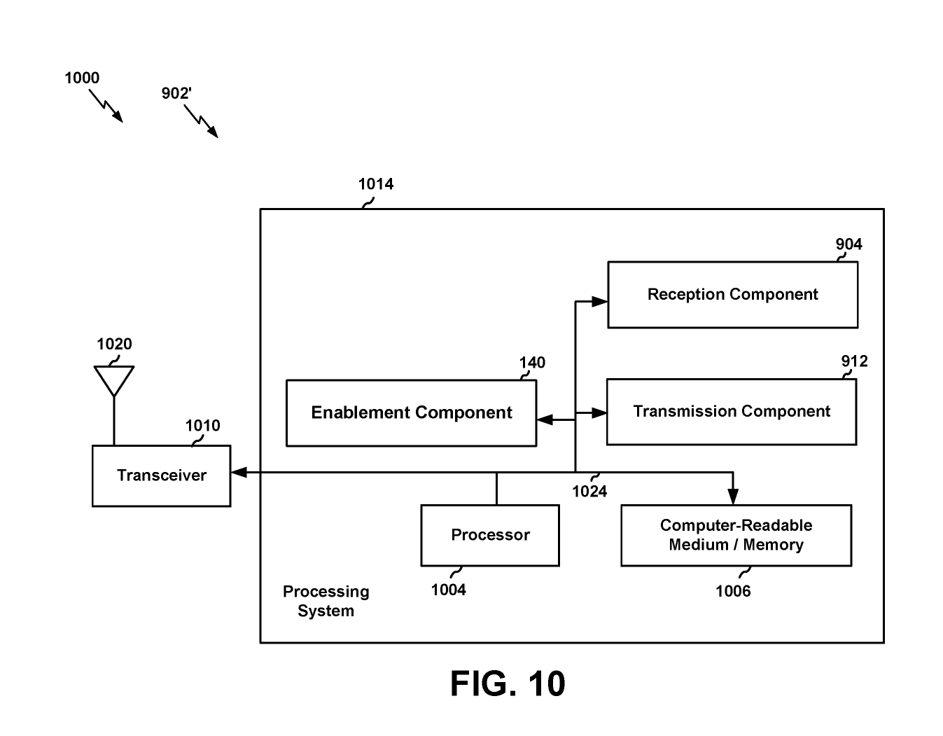

FIG. 10 is a diagram 1000 illustrating an example of a hardware implementation for an apparatus 902′ employing a processing system 1014 that includes enablement component 140. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware components, represented by the processor 1004, which may be the same as or similar to processor(s) 21 (FIG. 2), the components, 912, and the computer-readable medium/memory 1006, which may be the same as or similar to memory 45 (FIG. 2). The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The transceiver 1010 receives a signal from the one or more antennas 1020, extracts information from the received signal, and provides the extracted information to the processing system 1014, specifically the reception component 904. In addition, the transceiver 1010 receives information from the processing system 1014, specifically the transmission component 1012, and based on the received information, generates a signal to be applied to the one or more antennas 1020. The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software. The processing system 1014 further includes at least one of the components 140, 904, and 912. The components may be software components running in the processor 1004, resident/stored in the computer readable medium/memory 1006, one or more hardware components coupled to the processor 1004, or some combination thereof.

In one configuration, the apparatus 1002/902′ for wireless communication includes means for determining, based on one or more guard-band factors, a guard-band configuration message to configure one or more guard-bands of a RAT established with a UE. The apparatus further includes means for transmitting, to the UE over the RAT, the guard-band configuration message. Additionally, the apparatus includes means for communicating with the UE over an adjusted bandwidth of the transmission channel in response to the UE adjusting a bandwidth of each of the one or more guard-bands of the RAT based on the guard-band configuration message.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for dynamic bandwidth management for transmissions in unlicensed spectrum. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of wireless communications using flexible bandwidths, comprising:
receiving, at a user equipment (UE) from a network entity on a Radio Access Technology (RAT), a guard-band configuration message to configure one or more guard-bands of the RAT based on one or more guard-band factors;
adjusting a bandwidth of each of the one or more guard-bands of the RAT based on the guard-band configuration message, the adjusting further comprises adjusting a bandwidth of a transmission channel of the RAT based on adjusting the bandwidth of each of the one or more guard-bands of the RAT; and
communicating with the network entity over the adjusted bandwidth of the transmission channel in response to adjusting the bandwidth of each of the one or more guard-bands of the RAT.

2. The method of claim 1, wherein adjusting the bandwidth of the transmission channel of the RAT corresponds to adjusting a bandwidth of a low-end guard-band and a bandwidth of a high-end guard-band of the RAT.

3. The method of claim 2, wherein a first portion of the transmission channel is associated with an uplink channel bandwidth region and a second portion of the transmission channel is associated with a downlink channel bandwidth region, and wherein the guard-band configuration message includes information for configuring the low-end guard-band and the high-end guard-band associated with the uplink channel bandwidth region and the low-end guard-band and the high-end guard-band associated with the downlink channel bandwidth region.

4. The method of claim 2, wherein the guard-band configuration message includes information for configuring the low-end guard-band independently of configuring the high-end guard-band.

5. The method of claim 2, wherein the bandwidth of the low-end guard-band and the bandwidth of the high-end guard-band are fixed for the network entity based on a geographic area of the UE.

6. The method of claim 2, wherein the bandwidth of the low-end guard-band is different from the bandwidth of the high-end guard-band.

7. The method of claim 1, wherein adjusting the bandwidth of each of the one or more guard-bands comprises adjusting the bandwidth of each of the one or more guard-bands from a minimum bandwidth of each of the one or more guard-bands.

8. The method of claim 1, wherein the one or more guard-band factors correspond to at least one of a deployment band factor, a network category factor, or a user equipment (UE) specific factor.

9. The method of claim 1, wherein receiving the guard-band configuration message further comprises receiving, from the network entity within a control channel bandwidth region of the RAT, the guard-band configuration message.

10. A computer-readable medium storing computer executable code for wireless communications using flexible bandwidths, comprising:
code for receiving, at a user equipment (UE) from a network entity on a Radio Access Technology (RAT), a guard-band configuration message to configure one or more guard-bands of the RAT based on one or more guard-band factors;
code for adjusting a bandwidth of each of the one or more guard-bands of the RAT based on the guard-band configuration message, the adjusting further comprises adjusting a bandwidth of a transmission channel of the RAT based on adjusting the bandwidth of each of the one or more guard-bands of the RAT; and
code for communicating with the network entity over the adjusted bandwidth of the transmission channel in response to adjusting the bandwidth of each of the one or more guard-bands of the RAT.

11. The computer-readable medium of claim 10, wherein code for adjusting the bandwidth of the transmission channel of the RAT corresponds to code for adjusting a bandwidth of a low-end guard-band and a bandwidth of a high-end guard-band of the RAT.

12. An apparatus for wireless communications using flexible bandwidths, comprising:
a transceiver;
a memory configured to store data; and
one or more processors communicatively coupled with the transceiver and the memory, the one or more processors and the memory being configured to:
receive, at a user equipment (UE) from a network entity on a Radio Access Technology (RAT), a guard-band configuration message to configure one or more guard-bands of the RAT based on one or more guard-band factors;
adjust a bandwidth of each of the one or more guard-bands of the RAT based on the guard-band configuration message, the adjusting further comprises adjusting a bandwidth of a transmission channel the RAT based on adjusting the bandwidth of each of the one or more guard-bands of the RAT; and
communicate with the network entity over the adjusted bandwidth of the transmission channel in response to adjusting the bandwidth of each of the one or more guard-bands of the RAT.

13. The apparatus of claim 12, wherein the one or more processors configured to adjust the bandwidth of the transmission channel of the RAT are further configured to adjust a bandwidth of a low-end guard-band and a bandwidth of a high-end guard-band of the RAT.

14. The apparatus of claim 13, wherein a first portion of the transmission channel is associated with an uplink channel bandwidth region and a second portion of the transmission channel is associated with a downlink channel bandwidth region, and wherein the guard-band configuration message includes information for configuring the low-end guard-band and the high-end guard-band associated with the uplink channel bandwidth region and the low-end guard-band and the high-end guard-band associated with the downlink channel bandwidth region.

15. The apparatus of claim 13, wherein the guard-band configuration message includes information for configuring the low-end guard-band independently of configuring the high-end guard-band.

16. The apparatus of claim 13, wherein the bandwidth of the low-end guard-band and the bandwidth of the high-end guard-band are fixed for the network entity based on a geographic area of the UE.

17. The apparatus of claim 13, wherein the bandwidth of the low-end guard-band is different from the bandwidth of the high-end guard-band.

18. The apparatus of claim 12, wherein the one or more processors configured to adjust the bandwidth of each of the one or more guard-bands are further configured adjust the bandwidth of each of the one or more guard-bands from a minimum bandwidth of each of the one or more guard-bands.

19. The apparatus of claim 12, wherein the one or more guard-band factors correspond to at least one of a deployment band factor, a network category factor, or a user equipment (UE) specific factor.

20. The apparatus of claim 12, wherein the one or more processors configured to receive the guard-band configuration message are further configured receive, from the network entity within a control channel bandwidth region of the RAT, the guard-band configuration message.
